(19) United States
(12) Patent Application Publication
(10) Pub. No.: US 2011/0147327 A1
(43) Pub. Date: Jun. 23, 2011

(54) FLEXIBLE HINGE FOR A STRUCTURAL PANEL

(75) Inventor: Richard E. Verdicchio, Gananoque (CA)

(73) Assignee: The Orange Group Inc., Maple, CA (US)

(21) Appl. No.: 12/976,310

(22) Filed: Dec. 22, 2010

Related U.S. Application Data
(63) Continuation of application No. 11/414,474, filed on Apr. 28, 2006, now Pat. No. 7,861,374.
(60) Provisional application No. 60/675,912, filed on Apr. 29, 2005.

(51) Int. Cl. E05D 1/00; A47B 96/02; B21D 53/40

(52) U.S. Cl. 211/134; 16/225; 29/11

(57) ABSTRACT

A hinge unit useful in the manufacture of readily assembled and erect shelving and storage units and furniture comprises an elongate locking member adapted to be received within a slotted channel in the surface of a first panel, means extending away from the elongate member for attaching the hinge to a second panel and integral axial flexion means between the two portions of the hinge. The cross-sectional shape of the elongate locking member and the channel are selected to prevent rotation of the locking member within the channel.

### CROSS REFERENCE RELATED APPLICATION

This application is a continuation application, which is based on and claims priority to co-pending U.S. Utility patent application Ser. No. 11/414,474, filed on Apr. 28, 2006, which claims priority to Provisional Patent Application Ser. No. 60/675,912, filed Apr. 29, 2005, which is entirely incorporated herein by reference.

### FIELD OF THE INVENTION

This invention relates to a novel hinge system for connecting a pair of panel members so as to allow them to be stacked closely together but readily separated to a selected, fixed perpendicular spacing.

### BACKGROUND OF THE INVENTION

The hinge system of the invention is useful in the manufacture of easy to assemble and erect structures having two or more vertical or horizontal shelving units, for example, chests, bookshelves, closet organizers, tables and seating. A shelving unit or other structure incorporating the hinge system of the invention can be produced relatively simply and inexpensively by the manufacturer and requires no tools for assembly by the ultimate purchaser and user of the unit.

To achieve these advantages, a hinged panel assembly according to the invention comprises a first panel crossed by an elongate channel having a narrow entranceway; a second panel; a hinge having a first portion located in the channel of the first panel and protruding through the entranceway and a second portion which attaches to the second panel. The first and second portions of the hinge are pivotally connected together by axial flexion means, which can be a conventional hinge pin assembly or a “living” hinge.

The hinge unit connecting the panels itself comprises a dowel or other elongate locking member adapted to be received within a specially routed slotted channel in the surface of a first panel. A leaf member extends away from the elongate member along axial flexion means. The leaf member connects to one surface of a rigid cross piece so as to allow rotational motion of the cross piece in one angular direction, from an extended position perpendicular to the first panel to a folded position substantially parallel to and contiguous with the first panel.

When a second, corresponding hinge unit is installed on the facing surface of a second panel, with the leaf member of that second hinge unit connected to the opposite surface of the cross piece, then translation of the first and second panels in opposite directions results in the folding over of the cross piece and its sandwiching between the first and second panels as they come together.

A particular aspect of the invention is a new and simple method for hingedly connecting a pair of panels. A recess for receiving the dowel portion of the hinge unit is formed in the first panel by routing a narrow rectangular passage into the first panel, then routing a channel into the first panel in open communication with the narrow rectangular passage. The channel receives the dowel portion of the hinge unit, both the channel and the dowel portion having a cross-sectional shape which prevents rotation of the dowel within the channel. Novel router bits are provided for the purpose of forming a channel with narrow entranceway in the first panel or workpiece to receive the first portion of the hinge unit, which may be used with conventional routing tools.

### BRIEF DESCRIPTION OF THE FIGURES

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A and 1B are respectively disassembled and assembled schematic views of the hinge system of the invention according to a first embodiment (“pin edge”).

FIGS. 2A to 2C illustrate the erection or folding up of a two-shelf unit employing four of the hinge systems of FIG. 1.

FIG. 3 is a schematic view of a second embodiment (“flex hinge”) of hinge system according to the present invention.

FIG. 4A is a schematic view of a further example of a hinge system according to the second embodiment of the invention.

FIG. 4B is a different perspective view of the hinge system of FIG. 4A.

FIG. 5 illustrates a panel adapted to receive three hinge units according to the invention having elongate locking members of differing cross-sectional contour.

FIGS. 6A and 6B are schematic views of a third embodiment of hinge system according to the present invention, respectively showing the hinge partly and completely removed from the locking channel.

FIGS. 6C and 6D are two views of the hinge system of FIGS. 6A and 6B, fully assembled, with the panel and cross piece shown at two different angular spacings.

FIG. 7 is a perspective view of three examples of router bits for use in forming channels in panel members to receive hinge units according to the invention.

### DETAILED DESCRIPTION

In the drawings, 10 indicates a portion of a panel member, such as a shelf, which has been prepared for installation of a hinge unit according to the invention by routing therealong a channel 12 open to the surface along slot 13. An elongate locking member 14 of the hinge unit is configured to slide into channel 12 leaving axial flexion means projecting outwardly through slot 13 and connecting. In the drawings, for different embodiments of the hinge system, analogous components will be identified by the same numerals, but differing alphabetic subscripts.

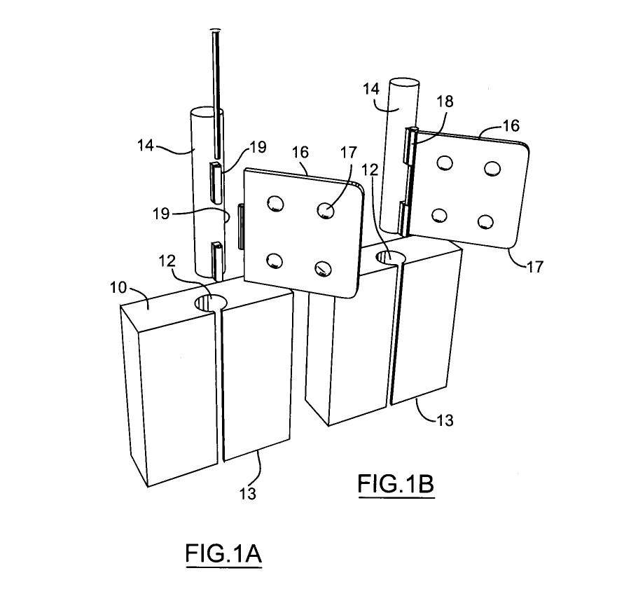

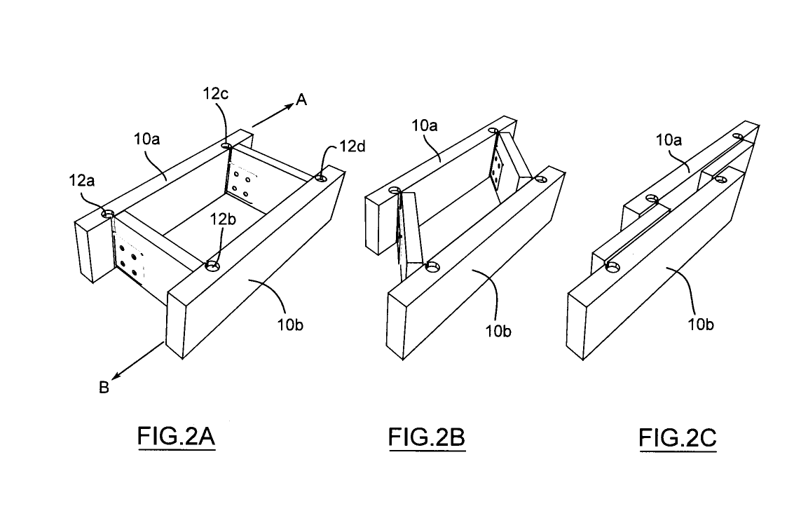

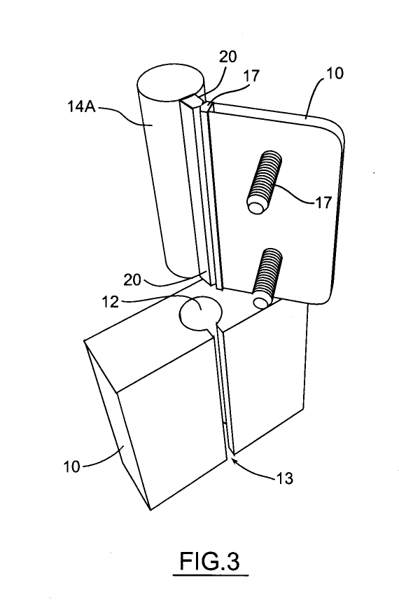

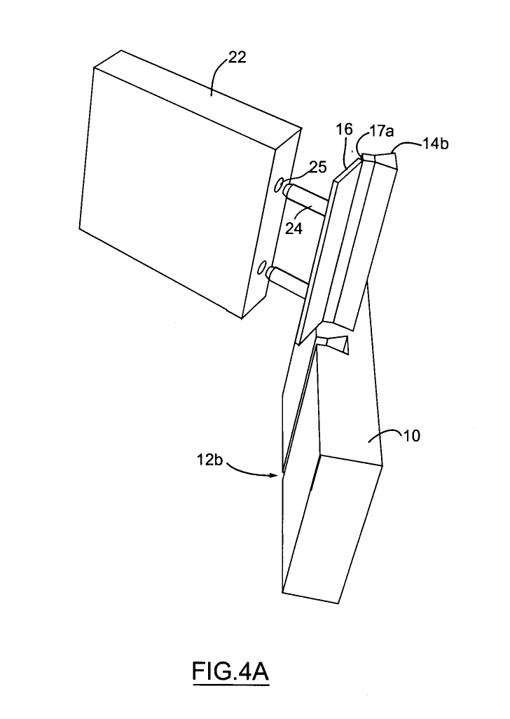

In the embodiment of hinge unit illustrated in FIGS. 1A to 2C (the “pin edge” arrangement) elongate locking member 14 is in the form of a circular dowel but, as will be noted below, other cross sections are possible and useful for particular applications.

Hinge leaf 16 is pivotably connected to member 14 by axial flexion means 18 which, in the embodiment illustrated, comprise aligned interfitting hinge eyes 19 for removably receiving a hinge pin 20 which holds the leaf 16 to the locking member 14, and allows the leaf to swing smoothly and freely relative to the facing surface of panel member 10. Leaf 16 may be provided with apertures 17 through which screws or other fastening means can be inserted to interconnect a pair of panel members. The locking member 14, hinge pin 20, hinge eyes 19 and the leaf 16 may be made of any machinable metal or alloy such as brass or steel.

A two-panel hinged interconnection according to the invention is illustrated in FIGS. 2A to 2C. Parallel panel members 10a and lob are provided with opposed pairs of routed channels (12a, 12b) and (12c, 12d). Hinge units as described in connection with FIGS. 1A and 1B are fitted into the routed channels in the facing panel members. Extending between opposed pairs of hinge units are cross pieces 22a and 22b, to which the leaves 16a and 16b of opposed hinges are attached to opposite surfaces of the cross piece. Translation of parallel panels 10a and l o b in the opposite directions indicated by arrows A and B then collapses the four-member structure (two panels/shelves and two cross pieces) into the flat, stackable arrangement of FIG. 2C.

The pin edge arrangement, employing metallic hinge components, is intended for heavy duty use. For smaller shelf or storage space installations, a light plastic living hinge structure is useful. A hinge unit of that kind is illustrated in FIG. 3.

The embodiment of hinge unit illustrated in FIGS. 3A and 38 is an integral hinge formed of an engineering plastic, in which flexion is afforded by a thinned portion or notch line 17 in the plastic material connecting leaf 16a to a narrow ledge extension 20 extending diametrically away from the locking member portion 14a and through the slot portion 13 of routed channel 12 in a panel member 10.

Suitable materials for manufacturing this “flex hinge” version of the hinge unit of the invention include engineering grades of polyvinyl chloride (PVC) copolymers of polystyrene [e.g. ABS], polyethylene, polypropylene and polyamides (nylon). With suitable materials, the entire hinge unit can be made in a single injection molding step.

The flex hinge of FIG. 3 can be used to form a collapsing shelf structure as in FIGS. 2A to 2C, just as with the pin edge metallic hinge unit of FIG. 1. For added locking stability, the flex hinge can be made with locking dowels 24 integral with and perpendicular to leaf 16a, for fitting into corresponding holes formed in the cross pieces of the structure (not shown in FIG. 3).

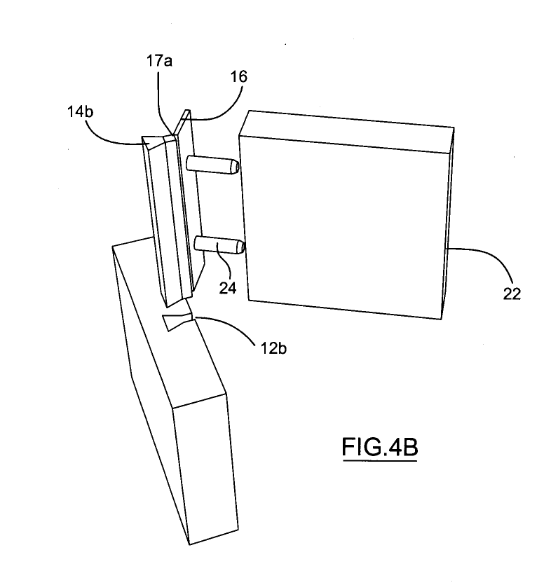

FIGS. 4, 4A and 48 show a flex hinge unit like that of FIG. 3, but with the elongate locking member indicated by 14b having a different, part-triangular cross-sectional shape. A mating slotted channel 12b is shown routed into the surface of a panel 10 to be hingedly joined to cross piece 22. Flexion at the hinge is about notch line 17a.

Again, leaf portion 16a is provided with locking dowels 24 which fit within mating recesses 25 in cross piece 22.

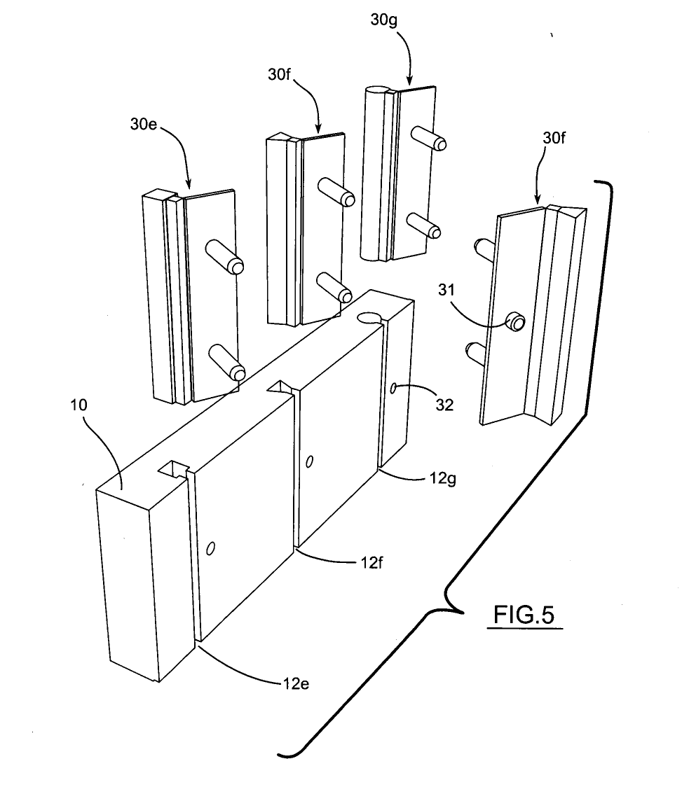

FIG. 5 shows a panel member 10 in which three different routed channel configurations 12e, 12f and 129 have been formed, respectively square, triangular and circular and adapted to connect with hinge units 30e, 30f and 309.

A second, reverse-side view is given of hinge unit 30f to show the provision on these units of integral projections 31 which, in fully assembled 5 configurations of the storage unit, fit into and engage corresponding recesses 32 on the panel (shelf) members for added stability of the erected structure.

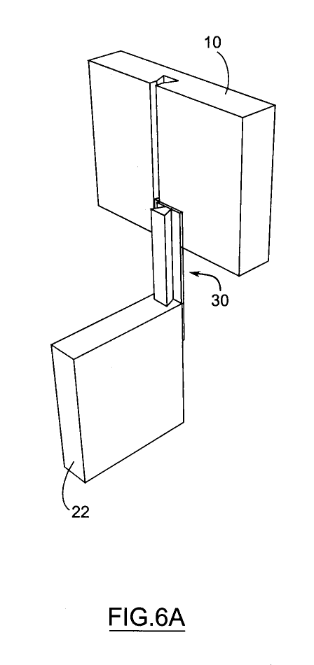

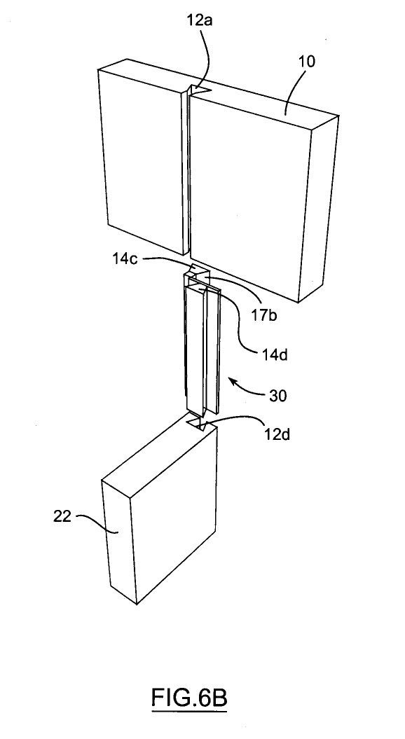

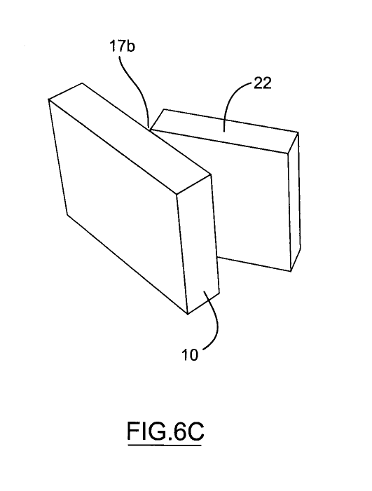

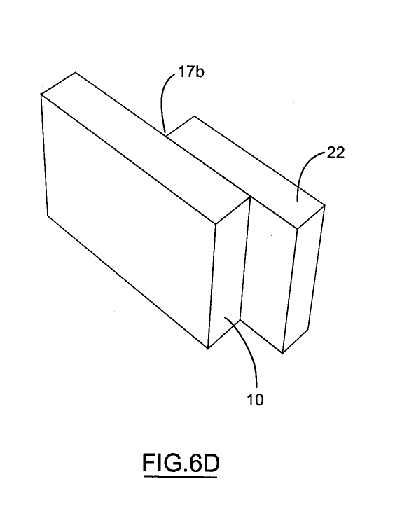

Particular ease of manufacture of hinges according to the present invention is illustrated by the “dovetail” version of hinge unit indicated by 30 in FIGS. 6A and 68. The hinge 30 may be made in indefinite lengths by extrusion molding and cutting to fully formed hinges of the desired length. The hinge contour comprises two elongate locking members 14c and 14d at opposite sides of axial flexion means. These locking members respectively engage with corresponding routed channels 12c which has been formed in the main panel member 10 and the cross pieces 22, respectively. The fully connected panel member 10 and row piece 22 are illustrated in FIG. 68, at two different angular spacings.

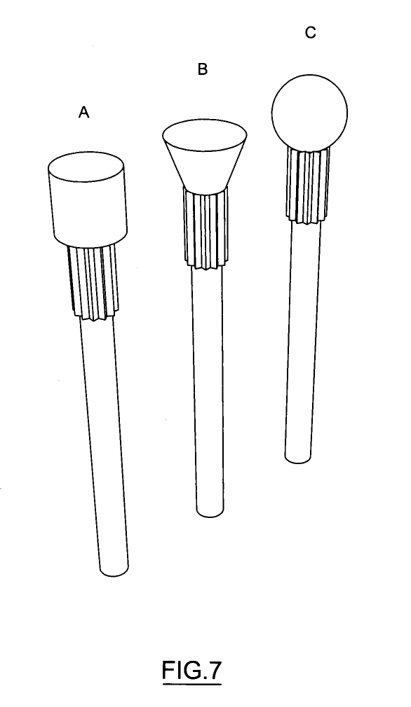

FIG. 7 illustrates three forms of router bit which have been developed to form slotted channels of different configurations. Thus, routers of shapes A, B and C have the configurations 12b in FIGS. 4 and 12a in FIG. 3, respectively.

While specific embodiments of the invention have been described, it will be appreciated by those skilled in the art that various modifications and alternatives could be developed in light of the overall teachings of the disclosure. Accordingly, the particular arrangements disclosed are meant to be illustrative only and not limiting as to the scope of the invention which is to be given the full benefit of all the claims appended and any and all equivalents.

What is claimed is:

1. A collapsible shelving unit constituted of a hinged panel assembly, comprising:
a first panel having an elongate channel with a narrow entranceway in a facing surface of the first panel;
a second panel;
a hinge fabricated of an engineering plastic material, having a first portion located in said elongate channel and protruding through the entranceway thereof, said channel and said first portion of the hinge having a cross-sectional shape to prevent rotation of the first portion; and
means for fixedly attaching a second portion of the hinge to said second panel, wherein said first and second portions of the hinge are pivotably connected together by axial flexion means comprising a thinned notch line in the plastic material between said first and second portions of the hinge; and
wherein said first panel and said second panel of the hinge include means for releasably locking together for added stability of the assembly.

2. A hinged panel assembly according to claim 1, wherein said means for releasably locking together comprises a convex projection on said second portion of the hinge and a corresponding mating recess on said first panel.

3. A hinged panel according to claim 1, wherein said means for attaching the second portion of the hinge to the second panel comprises a second elongate channel in the second panel, said second channel and said second portion of the hinge a cross-sectional shape to prevent rotation of the second portion.

4. A hinged panel assembly according to claim 1, wherein said means for attaching said second portion of the hinge to the second panel comprises at least one locking dowel perpendicularly fixed to said second portion of the hinge and a mating recess in said second panel for receiving said at least one locking dowel.

5. A hinge for connecting a first panel and a second panel of a foldable furniture assembly, comprising:
a first panel having a facing surface with a channel formed therein,
a first portion adapted to be located in said channel, said channel having a narrow entranceway, said channel and said first portion having a cross-sectional shape to prevent rotation of the first portion; and
a second portion with means for attachment to the second panel,
said first and second portions being flexibly connected to allow relative angular motion of said panels between parallel, in a folded configuration, and perpendicular, in an assembled configuration.

6. A hinge according to claim 5, wherein the narrow entranceway of the channel is a rectangular slot and said first portion of the hinge has a ledge formation projecting through and closely fitting within said slot for sliding movement therealong.

7. A hinge according to claim 6, wherein said hinge is fabricated of an engineering plastic material having a living hinge line and said first and second portions meet along said living hinge line in the plastic material.

8. A hinge according to claim 6, wherein the cross-sectional shape of said channel is substantially circular.

9. A hinge according to claim 6, wherein the cross-sectional shape of said channel is substantially triangular.

10. A hinge according to claim 6, wherein the cross-sectional shape of said channel is substantially rectangular.

11. A hinged panel assembly according to claim 5, wherein said first panel and said second portion of the hinge include means for releasably locking together for added stability of the assembly.

12. A hinged panel assembly according to claim 5, including axial flexion means comprising a hinge pin and eye formations in said first and second portions adapted to overlap and to receive the hinge pin.

13. A hinged panel assembly according to claim 5, wherein said second panel has an elongate channel with a narrow entranceway and said second portion is located in the elongate channel of said second panel and protrudes through the entranceway thereof.

14. A method for hingedly connecting a first panel and a second panel, comprising the steps of:
forming a channel and a narrow entranceway thereinto in one panel formed by routing a narrow rectangular passage into the first panel to serve as said narrow entranceway, then routing a channel into the first panel, said channel having a selected cross-sectional contour; and
providing a hinge having a first portion adapted to be non-rotatably located in the channel, said hinge having a second portion adapted to be attached to the second panel, whereby said first and second panels may be hingedly connected together.

15. A method according to claim 14, wherein said channel and narrow entranceway are formed by routing a narrow rectangular passage into the first panel to serve as said narrow entranceway, then routing a channel into the first panel, said channel having a selected cross-sectional contour.
